(19) United States
(12) Patent Application Publication
(10) Pub. No.: US 2024/0353986 A1
(43) Pub. Date: Oct. 24, 2024

(54) INTERACTION METHOD AND APPARATUS, AND ELECTRONIC DEVICE AND READABLE STORAGE MEDIUM

(71) Applicant: Beijing Youzhuju Network Technology Co., Ltd., Beijing (CN)

(72) Inventor: Kai ZHANG, Beijing (CN)

(21) Appl. No.: 18/761,176

(22) Filed: Jul. 1, 2024

Related U.S. Application Data
(63) Continuation of application No. PCT/CN2022/141133, filed on Dec. 22, 2022.

(30) Foreign Application Priority Data
Dec. 31, 2021 (CN) 202111667974.1

(51) Int. Cl. G06F 3/0484; G06F 3/0481; H04L 51/52; H04N 23/63

(52) U.S. Cl. CPC G06F 3/0484; G06F 3/0481; H04L 51/52; H04N 23/632

(57) ABSTRACT

An interaction method and apparatus, and an electronic device, a readable storage medium and a computer program product. The method includes: via a trigger operation for a target shooting control corresponding to a target object in an object display page, acquiring a target prop corresponding to the target object; performing shooting by using a prop corresponding to the target object, so as to acquire target multimedia content; sending the target multimedia content and posting information to a server, such that the server determines whether a preset condition is met; and receiving resource guidance information, which is sent by the server when the same determines that the preset condition is met.

This application is a continuation of International Application No. PCT/CN2022/141133, as filed on Dec. 22, 2022, which is based on and claims the priority to the Chinese application No. 202111667974.1 filed on Dec. 31, 2021. The disclosure of each of these applications is incorporated by reference herein in its entirety.

### TECHNICAL FIELD

The present disclosure relates to the field of Internet technology, and in particular, to an interaction method and apparatus, and an electronic device and a readable storage medium.

### BACKGROUND

With the continuous development of Internet technology, a user may use a client to shoot and post multimedia content, and the multimedia content posted by the user can be watched and replied by other users. At present, if the user wants to post the multimedia content, he needs to enter a shooting page through a shooting entry, select a prop he wants to use in the shooting page for shooting, and then edit and post the multimedia content.

### SUMMARY

Some embodiments of the present disclosure provide an interaction method and apparatus, an electronic device and a readable storage medium.

In a first aspect, the present disclosure provides an interaction method, comprising:
displaying an object presenting page on which a target shooting control corresponding to a target object is presented;
in response to a trigger operation for the target shooting control, acquiring a target prop corresponding to the target object;
performing shooting according to the target prop to acquire target multimedia content;
in response to a posting operation for the target multimedia content, transmitting the target multimedia content and corresponding posting information to a server, such that the server determines whether a preset condition is met; and
receiving resource guidance information which is transmitted by the server in response to the server determining that the preset condition is met.

As a possible implementation, the method further comprises:
displaying the resource guidance information; and
in response to a trigger operation for the resource guidance information, presenting target resource information.

As a possible implementation, the preset condition comprises at least one of: the posting information comprising topic information associated with the target object, the posting information comprising client information associated with the target object, or the target multimedia content comprising target prop information.

As a possible implementation, the in response to a trigger operation for the target shooting control, acquiring a target prop corresponding to the target object, comprises:
in response to the trigger operation for the target shooting control, acquiring identification information of the target object; and
acquiring the prop corresponding to the target object according to the identification information of the target object.

As a possible implementation, the in response to a posting operation for the target multimedia content, transmitting the target multimedia content and corresponding posting information to a server, comprises:
in response to the posting operation for the target multimedia content, acquiring posting information corresponding to the target object which comprises client information associated with the target object; and
transmitting the target multimedia content and the client information to the server, such that the server transmits the target multimedia content to a client corresponding to the client information.

As a possible implementation, the in response to a posting operation for the target multimedia content, transmitting the target multimedia content and corresponding posting information to a server, comprises:
in response to the posting operation for the target multimedia content, acquiring posting information corresponding to the target object which comprises topic information associated with the target object; and
transmitting the target multimedia content and the topic information to the server, such that the server adds the target multimedia content to a multimedia content collection corresponding to the topic information.

As a possible implementation, the in response to a posting operation for the target multimedia content, transmitting the target multimedia content and corresponding posting information to a server, comprises:
in response to the posting operation for the target multimedia content, acquiring posting information corresponding to the target object;
receiving a modification operation for the posting information;
acquiring modified posting information; and
transmitting the target multimedia content and the corresponding modified posting information to the server.

In a second aspect, the present disclosure provides an interaction method, comprising:
receiving target multimedia content and corresponding posting information which are transmitted by a client;
determining whether a preset condition is met according to the target multimedia content and the corresponding posting information; and
transmitting resource guidance information to the client in response to determining that the preset condition is met.

In a third aspect, the present disclosure provides an interaction apparatus, comprising:
a display module configured to display an object presenting page on which a target shooting control corresponding to a target object is presented;
a processing module configured to, in response to a trigger operation for the target shooting control, acquire a target prop corresponding to the target object; and perform shooting according to the target prop to acquire target multimedia content; and
a communication module configured to, in response to a posting operation for the target multimedia content, transmit the target multimedia content and corresponding posting information to a server, such that the server determines whether a preset condition is met,
wherein the communication module is further configured to receive resource guidance information which is transmitted by the server in response to the server determining that the preset condition is met.

In a fourth aspect, the present disclosure provides an interaction apparatus, comprising:
a communication module configured to receive target multimedia content and corresponding posting information which are transmitted by a client; and
a processing module configured to determine whether a preset condition is met according to the target multimedia content and the corresponding posting information;
wherein the communication module is further configured to transmit resource guidance information to the client in response to determining that a preset condition is met.

In a fifth aspect, the present disclosure provides an electronic device, comprising: a memory and a processor;
wherein the memory is configured to store computer program instructions; and
the processor is configured to execute the computer program instructions to cause the electronic device to implement the interaction method of any of the first aspect or the interaction method of any of the second aspect.

In a sixth aspect, the present disclosure provides a readable storage medium, comprising: computer program instructions; wherein the computer program instructions, when executed by at least one processor of an electronic device, causing the electronic device to implement the interaction method of any of the first aspect or the interaction method of any of the second aspect.

In a seventh aspect, the present disclosure provides a computer program product which, when executed by a computer, implements the interaction method of any of the first aspect, or the interaction method of any of the second aspect.

### BRIEF DESCRIPTION OF THE DRAWINGS

The accompanying drawings herein, which are incorporated in and constitute a part of this specification, illustrate embodiments consistent with the present disclosure and, together with the description, serve to explain the principles of the present disclosure.

In order to more clearly illustrate technical solutions in the embodiments of the present disclosure or the related art, the drawings required for use in the description of the embodiments or the related art will be briefly described below, and it is apparent for those skilled in the art that other drawings can be obtained according to these drawings without paying creative labor.

FIG. 1 is a schematic diagram of an application scenario of an interaction method according to an embodiment of the present disclosure;

FIGS. 2A-2M are schematic diagrams of human-computer interactive interfaces according to the present disclosure;

FIG. 3 is a schematic flow diagram of an interaction method according to an embodiment of the present disclosure;

FIG. 4 is a schematic flow diagram of an interaction method according to another embodiment of the present disclosure;

FIG. 5 is a schematic structural diagram of an interaction apparatus according to an embodiment of the present disclosure;

FIG. 6 is a schematic structural diagram of an interaction apparatus according to an embodiment of the present disclosure;

FIG. 7 is a schematic structural diagram of an electronic device according to an embodiment of the present disclosure.

### DETAILED DESCRIPTION

In order that the above objectives, features and advantages of the present disclosure may be more clearly understood, solutions of the present disclosure will be further described below. It should be noted that, without conflict, the embodiments of the present disclosure and features in the embodiments may be combined with each other.

In the following description, numerous specific details are set forth in order to provide a thorough understanding of the present disclosure, but the present disclosure may be implemented in other ways different from those described herein; and it is apparent that the embodiments in the description are only part of the embodiments of the present disclosure, rather than all of them.

With the continuous development of Internet technology, a user may use a client to shoot and post multimedia content, and the multimedia content posted by the user can be watched and replied by other users. At present, if the user wants to post the multimedia content, he needs to enter a shooting page through a shooting entry, select a prop he wants to use in the shooting page for shooting, and then edit and post the multimedia content.

The above mode is limited in the aspect of the shooting of the multimedia content, so that the interaction mode is too single to meet diversified interaction requirements, affecting the user experience.

The present disclosure provides an interaction method and apparatus, and an electronic device, a readable storage medium and a computer program product, wherein the method comprises: by means of a trigger operation for a target shooting control corresponding to a target object in an object presenting page, acquiring a target prop corresponding to the target object; performing shooting by using the prop corresponding to the target object to acquire target multimedia content; transmitting the target multimedia content and posting information to a server, such that the server determines whether a preset condition is met; and receiving resource guidance information which is transmitted by the server in response to the server determining that the preset condition is met. The interaction method provided in the present disclosure can improve the interaction experience, and meet diversified interaction requirements.

The target shooting control corresponding to the target object can be taken as an entry for obtaining the prop corresponding to the object, so as to achieve that the multimedia content capable of participating in target interaction is obtained by using the target prop.

FIG. 1 is a schematic diagram of an application scenario of an interaction method according to an embodiment of the present disclosure. The scenario 100 illustrated with reference to FIG. 1 includes: a terminal device 101 and a server 102, and data can be interacted between the terminal device 101 and the server 102.

Exemplarily, the terminal device 101 may be an electronic device including a smart home device such as a cellphone, a tablet computer, a wearable electronic device, a vehicle-mounted device, an augmented reality (AR)/virtual reality (VR) device, a laptop computer, an ultra-mobile personal computer (UMPC), a netbook, a personal digital assistant (PDA), a smart TV, a smart screen, a high-definition TV, a 4K TV, a smart speaker, a smart projector, or the like, and the specific type of the electronic device is not limited in the present disclosure. The type of an operating system of the electronic device is not limited in the present disclosure, for example, an Android system, a Linux system, a Windows system, an iOS system, or the like.

The server 102 may be a stand-alone controller device, such as a master server or the like; and can also be a network-supported device such as a switch or the like; or can also be a cloud service platform, an Internet of Things service platform, or the like.

The server 102 may issue, to the terminal device 101, information of a prop corresponding to each object, information of a target client corresponding to each object, information of a target topic corresponding to each object, and the like. The terminal device 101 may also upload, to the server 102, multimedia content edited and obtained using a target prop, information of a client to be notified which is set by the user, information of a topic to participate which is set by the user, result data of performing target interaction behavior, and the like, and the server 102 may respond to the received information or data described above.

In the embodiment shown in FIG. 1, the server 102 interacts with one terminal device 101, and in an actual scenario, the server 102 may interact with a plurality of terminal devices 101 synchronously, such that the terminal device 101 implements the interaction method provided in the present disclosure.

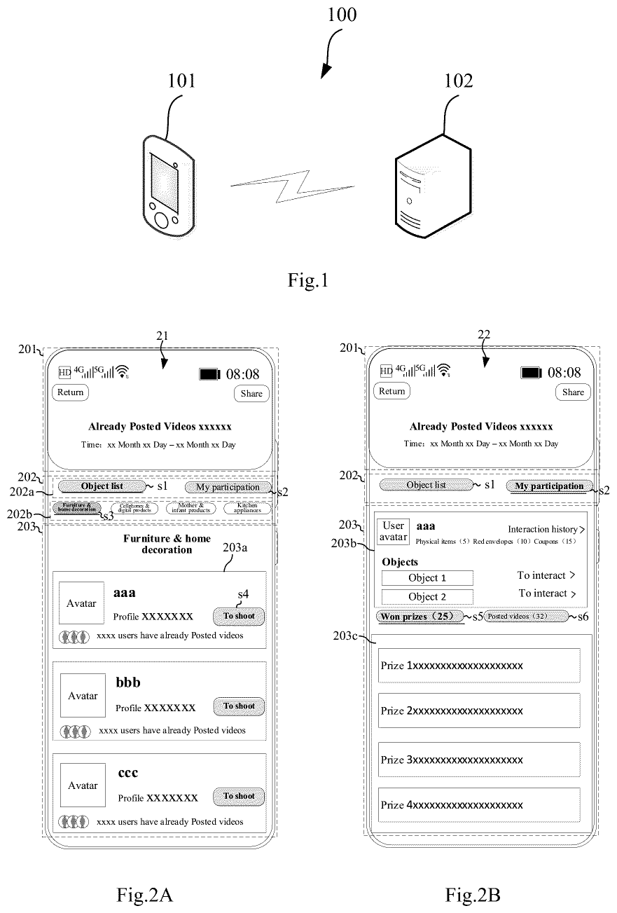

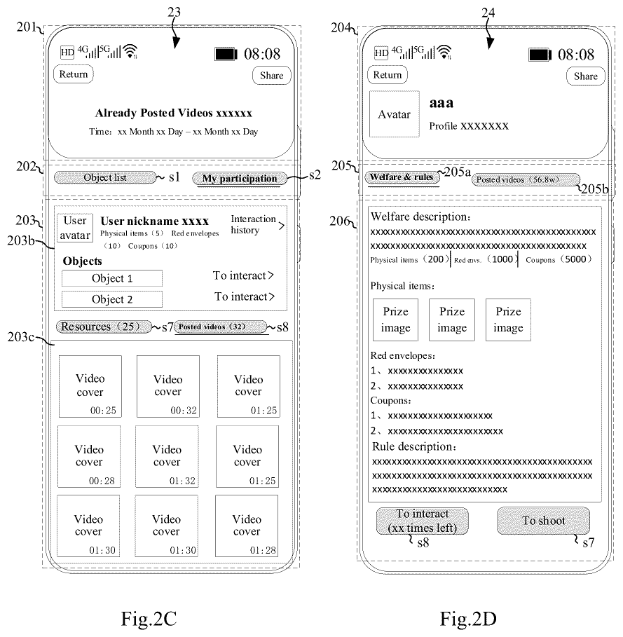

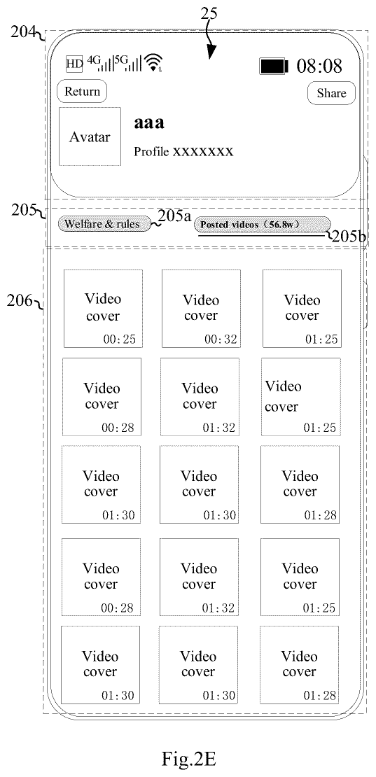

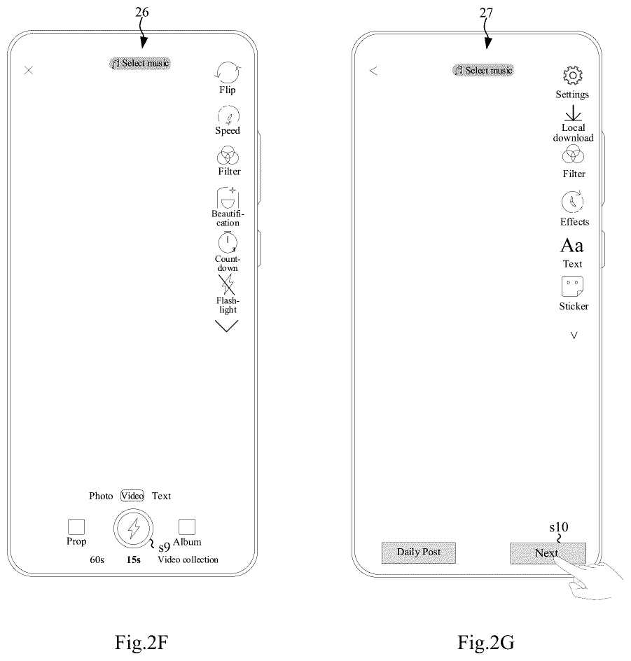

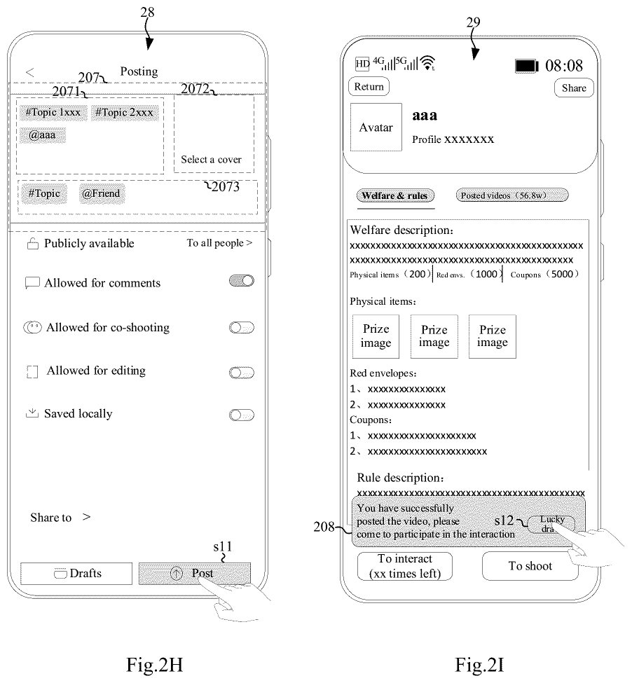

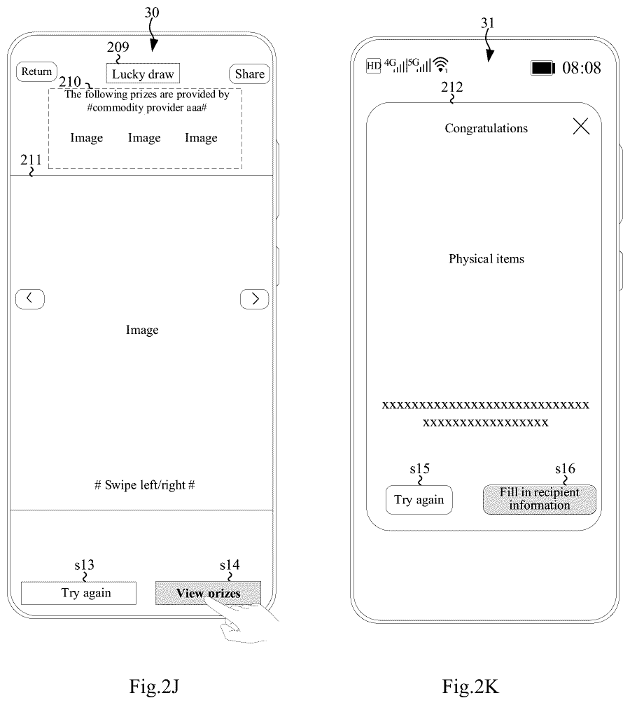

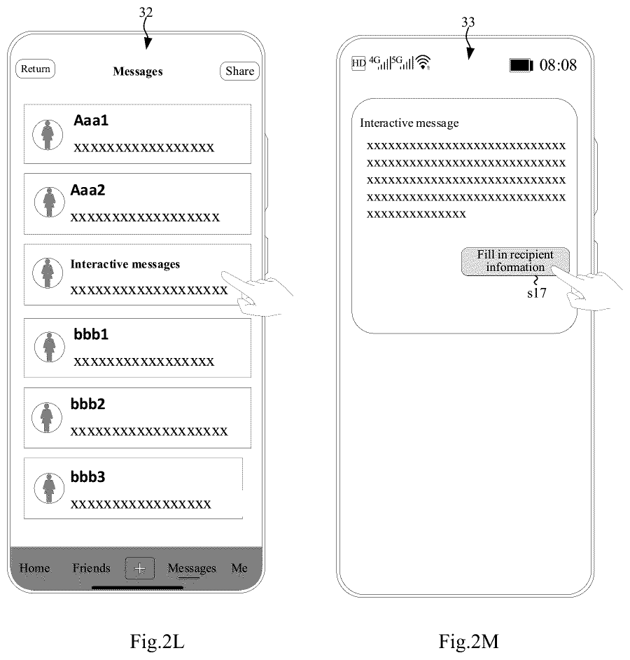

Based on the foregoing description, next, by taking an example that the electronic device is a cellphone and the cellphone has therein installed a client (hereinafter shortened to an application 1), a specific implementation process of the interaction method provided in the present disclosure will be described in detail through FIGS. 2A to 2M.

Referring to FIGS. 2A to 2M, they are schematic diagrams of human-computer interactive interfaces according to embodiments of the present disclosure. FIGS. 2A to 2M are described by taking an example that the cellphone is in a portrait screen state.

The application 1 may display, on the cellphone, an interactive interface 21 as shown in FIG. 2A, wherein the interactive interface 21 is used for displaying, in the application 1, an object presenting page which includes related information of a plurality of objects, for example, an identification, a name, a profile, and the like of the object; in addition, each object in the object presenting page corresponds to one shooting control. With the shooting control, a prop corresponding to the object can be acquired, and then shooting can be performed by using the prop.

The object mentioned in the present disclosure may be a commodity promoter, a commodity provider, or the like.

The prop corresponding to the object may be a prop individually preset for each object, associated with the object, and corresponding to the object, and may be a prop having an object characteristic attribute. Specifically, if the object is the commodity promoter (e.g., an anchor), the prop corresponding to the object may be a preset prop associated with the anchor, and may also be a prop having an anchor characteristic attribute (e.g., an anchor identification, an anchor avatar identification, an anchor nickname identification, or the like); and, if the object is the commodity provider (e.g., a store, a merchant), the prop corresponding to the object may be a preset prop associated with the store, and may also be a prop having a store characteristic attribute (e.g., a store identification, a store avatar identification, a store nickname identification, or the like).

In the following embodiments, the descriptions such as “object 1”, “object 2”, “object 3”, and the like are used as schematic examples, wherein a name of the object 1 is aaa, a name of the object 2 is bbb, and a name of the object 3 is ccc.

In FIG. 2A, the interactive interface 21 includes: areas 201, 202, and 203.

The area 201 may be a head area of the object presenting page, in which a specified image may be presented, and in which information associated with the object presenting page may also be presented, for example, a total number of users who post multimedia content using the props corresponding to the objects in the object presenting page, a time range in which the users may post the multimedia content using the props corresponding to the objects in the object presenting page, a rule information entry related to the object presenting page, and the like.

The area 202 is a navigation area for presenting navigation information related to the object presenting page. In the area 202, a plurality of levels of navigation bars may be included, and there may be a hierarchical relationship between the plurality of levels of navigation bars, such that if one or more labels in an upper-level navigation bar have a fine classification, a lower-level navigation bar may be used for displaying finely classified labels of a label positioned in the upper-level navigation bar. If a label in an upper-level navigation bar has no fine classification, a lower-level navigation bar may not be displayed.

The area 203 may have therein displayed corresponding content according to a label positioned in the navigation area. The parameters such as display shape, display size, display position, and the like of the area 203 are not limited in the present disclosure. For example, referring to FIG. 2A, the area 203 may be a rectangular area, which includes a relatively large area of a display screen of the cellphone, and a lower edge of which proximate to a lower edge of the screen of the cellphone.

Exemplarily, referring to FIG. 2A, the interactive interface 21 may include a first navigation bar 202a and a second navigation bar 202b. The first navigation bar 202a may include labels s1 and s2. The second navigation bar 202b is used for presenting finely classified labels of a label positioned in the first navigation bar 202a.

The label s1 may be used for triggering presenting related information corresponding to the objects in the area 203. And when it is positioned to the label s1 in the first navigation bar 202a, a plurality of category labels s3 may be displayed in the second navigation bar 202b.

In order to enable the user to quickly position an object with which the user wants to interact, assuming that a plurality of different categories are divided according to the related attribute information of the objects in advance, the user can, by triggering the category label, view related information of an object corresponding to the category. The implementation of how the categories are divided is not limited in the present disclosure. Assuming that the plurality of objects in the above object presenting page are commodity providers, classification may be made according to categories to which commodities provided by the commodity providers belong, for example, a plurality of categories such as furniture and home decoration, cellphones and digital products, mother and infant products, and the like may be included.

Assuming that it is currently positioned to the label s3 corresponding to a category 1 (such as furniture and home decoration), related information of a plurality of objects corresponding to the category 1 is presented in the area 203, wherein the related information includes, for example, but is not limited to one or more of: an identification (such as logo) of the object, a name of the object, a profile of the object, resource information associated with the object, a quantity of multimedia content posted using a prop corresponding to the object, and the like.

In the area 203, each object may correspond to one presenting unit 203a, and related information of a corresponding object is presented in a corresponding presenting unit 203a. The presenting units 203a respectively corresponding to the plurality of objects may be arranged and presented in the area 203 in an order from top to bottom. Of course, they may also be arranged in other manners, for example, in an order from left to right and from top to bottom, and each row corresponds to a plurality of presenting units. The presenting manner of the plurality of presenting units 203a in the area 203 is not limited in the present disclosure.

Exemplarily, in the interactive interface 21, due to the limitation of the screen size of the cellphone, the area 203 includes three presenting units 203a, which correspond to the object 1, the object 2, and the object 3, respectively, and are used for presenting the related information of the object 1, the object 2, and the object 3, respectively.

In addition, in the area 203a, for each object, a corresponding shooting control s4 may also be presented, through which a prop corresponding to a triggered object can be acquired, and a shooting process is entered. In order that the relationship between the shooting control s4 and the object can be clearly presented, the shooting control s4 corresponding to each object may be presented in the presenting unit 203a corresponding to the corresponding object, so as to enable the user to clearly know the object associated with the shooting control s4.

The label s2 may be used for triggering displaying, in the area 203, a detail page regarding posting multimedia content using the props corresponding to the objects. When it is positioned to the label s2, an interactive interface 22 as shown in FIG. 2B can be exemplarily displayed on the cellphone.

Referring to FIG. 2B, in the interactive interface 22, the area 203 includes an area 203b and an area 203c.

The area 203b may have therein displayed an avatar of a user corresponding to the application 1, a nickname of the user, and resource-related information corresponding to the application 1, such as the number of resources. The user is one logging in to the application 1 on the electronic device.

A resource acquired by posting multimedia content using a prop corresponding to a certain object includes one or more resources acquired from resources provided by this object, and the resources provided by this object may be but are not limited to: virtual gifts, physical items, points, coupons, red envelopes, and the like.

The area 203c may have therein displayed detailed information of each type of resources acquired after multimedia content is posted using prop(s) corresponding to one or more objects, for example, a name of the each type of resources, the number of the each type of resources, and the like. Assuming that the object displayed in the area 203c is a commodity provider and resources provided by the commodity provider include three types of resources, namely, physical items, coupons, and red envelopes, the area 203c may have therein displayed the number of obtained physical items, the number of obtained coupons, the number of obtained red envelopes, and the like.

Alternatively, the area 203c may have therein displayed a collection of multimedia content posted using prop(s) corresponding to one or more objects.

Content specifically displayed in the area 203c can be controlled by labels s5 and s6. The implementation of the labels s5 and s6 is not limited in the present disclosure. The labels s5 and s6 may be implemented in a manner of text, an icon, a symbol, or the like, and the label s5 may have therein displayed statistical information of the each type of resource obtained, and the label s6 may have therein displayed the quantity of multimedia content included in the multimedia content collection.

Exemplarily, if it is positioned to the label s5, detailed information of each type of resources acquired after multimedia content is posted using prop(s) corresponding to one or more objects may be displayed in the area 203c; if it is positioned to the label s6, a multimedia content collection posted using prop(s) corresponding to one or more objects may be displayed in area 203c.

FIG. 2B exemplarily illustrates a case wherein detailed information of each type of obtained resources is displayed in the area 203c. For example, a name of the resource, a detailed description of the resource, and the like may be included.

FIG. 2C exemplarily illustrates a collection of multimedia content posted using prop(s) corresponding to one or more objects in an area 203c. Referring to FIG. 2C, the area 203c includes a plurality of presenting units, each for presenting information of one multimedia content posted, for example, a cover of the multimedia content, an identification of an object associated with the multimedia content, a duration of the multimedia content, and the like; and the presenting manner of such information in the presenting unit is not limited, for example, such information may be as close as possible to an edge area of the presenting unit, and does not block the cover of the multimedia content as possible. In addition, in the embodiment shown in FIG. 2C, in the area 203c, information of an object associated with the video may also be presented in the presenting unit, for example, when the associated object is a commodity provider, a logo of the commodity provider may be presented in the presenting area.

Referring to FIG. 2A, on the basis of the embodiment shown in FIG. 2A, when it is positioned to the label s1 in the first navigation bar 202A and the second navigation bar 202b is positioned to the label s3 corresponding to the category 1, the area 203 has therein displayed related information of first three objects, i.e., the object 1, the object 2, and the object 3, respectively, corresponding to the category 1.

When the application 1 receives a trigger operation (e.g., a click operation) for a shooting control s4 corresponding to any object, an interactive interface 24 as shown in FIG. 2D may be exemplarily displayed on the cellphone. In order to enable the user to clearly understand the detailed information of the triggered object, the application 1 responds to the trigger operation for the shooting control s4.

Assume that the application 1 receives a trigger operation for a shooting control s4 of the object 1 in the area 203 in the interactive interface 21 shown in FIG. 2A.

Referring to FIG. 2D, the interactive interface 24 includes: areas 204, 205, and 206.

In the area 204, an identification related to the object 1, a name of the object 1, a profile of the object 1, and the like may be presented. Other information related to the object 1 may also be presented in the area 204, which is not limited in this disclosure.

The area 205 may have therein presented a label for controlling content displayed in the area 206. For example, the area 205 includes labels 205a and 205b.

When it is positioned to the label 205a, the area 206 may have therein presented related information of the resources related to the object 1, such as a description of the resources provided by the object 1, a rule description of acquiring the resource provided by the object 1, and the like. The above related information can be realized in a combination manner of one or more of text, image, and the like. For example, the object 1 is a commodity provider, and resources provided by the commodity provider include: three types of resources, i.e., physical items, coupons, and red envelopes, then the area 206 may have therein presented the description of the three types of resources, i.e., the physical items, the coupons, and the red envelopes, which are provided by the commodity provider, for example, parameter information of the physical items, the number of the coupons, the number of the red envelopes, and the like; in addition, the area 206a may have therein presented a rule description of acquiring the resource provided by the commodity provider.

Of course, in the area 206, other content related to the resources related to the object 1 may also be presented, which is not limited in the present disclosure.

The interactive interface 24 may further include an entry label s7 for acquiring the prop corresponding to the object 1 and entering the shooting page. The interactive interface 24 may further include an entry label s8 for entering an interactive page, and when the user triggers a trigger operation for the entry label s8, he may enter the interactive page, and the user may obtain the resource provided by the object 1 by performing an operation in the interactive page.

The display manner of the entry labels s7 and s8 is not limited in the present disclosure, for example, as shown in FIG. 2D, the entry labels s7 and s8 may be located in the area 206 and do not block the related information of the resources related to the object 1 displayed in the area 206.

In addition, the user 1 might have posted the target multimedia content meeting a preset condition by using the prop corresponding to the object 1 for many times before, then a permission to acquire the resource provided by the object 1 can be obtained every time he posted, but the permission is not used immediately by the user 1, then the permission can be accumulated, that is, the number of times that the resource provided by the object 1 can be acquired can be accumulated. Therefore, the number of times that the resource provided by the object 1 can be acquired can be presented in the entry label s8, for example, there is a permission to acquire the resource provided by the object 1 three times, then in the interactive interface 24, text content “3 times left” can also be presented in the entry label 8.

In addition, in the interactive interface 24, a Share control, a Return control, and the like may also be included; when the application 1 receives a trigger operation for the Share control, the application 1 may be triggered to present a sharing page, in which a label of a sharable object, a control for determining to share, and the like may be presented, and when the application 1 receives a trigger operation for the Return control, the application 1 may return to the interactive interface 21 shown in FIG. 2A.

The application 1, in response to a trigger operation of the user for the label 205b in the area 205, may display, in the area 206, a collection of videos posted using the prop corresponding to the object 1. Exemplarily, referring to an interactive interface 25 shown in FIG. 2E, when the video collection is presented in the area 206, the videos may be arranged according to a video posting time, such that a video posted earlier is arranged at a lower position and a video posted later is arranged at a higher position in the area 206. In the area 206, each video may correspond to one presenting unit in which information such as a cover of the video, a duration of the video, and the like may be presented.

Referring to the embodiment shown in FIG. 2D, when the application 1 receives a trigger operation for the entry label s7, the application 1 may, on the cellphone, exemplarily display an interactive interface 26 shown in FIG. 2F.

Referring to FIG. 2F, the interactive interface 26 is used for presenting a shooting page. The shooting page may include a set of a plurality of functions, and is primarily used for acquiring an image material for the target multimedia content. The acquisition manner of the image material for generating the target multimedia content is not limited in the present disclosure. For example, the image material for the target multimedia content may be a photograph and/or video shot in real time.

Referring to FIG. 2F, the interactive interface 26 includes a shooting control s9; the application 1 receives a Start-Shooting trigger operation (e.g., a click operation or a long press operation) for the shooting control s9, and in response to the trigger operation for the shooting control s9, the application 1 may start recording a video, and when the recorded video reaches a preset duration or the application 1 receives an End-Shooting trigger operation (e.g., a click operation or a pop-up operation) for the shooting control s9, the application 1 ends recording the video, and the recorded video is the image material.

It should be noted that, by means of multiple trigger operations for the shooting control s9, the application 1 may record a plurality of video clips, which are the image material for the target multimedia content. Parameters such as a duration, aspect ratio, duration, filter effect, flash effect, resolution, and the like of the image material are not limited in the present disclosure.

It should be noted that, when the application 1 receives the trigger operation for the entry label s7, the application 1 may load the prop corresponding to the object 1, so as to perform shooting using the prop corresponding to the object 1. The application 1 may download prop parameter information corresponding to each object in advance, and store the information in a storage module of the cellphone, and when the user enters the shooting page in the manner as described above, he may acquire the prop corresponding to the object 1 from the storage module of the cellphone according to an identification of the object 1 (for example, an ID of the object 1), or the application 1 may also acquire the prop corresponding to the object 1 from the server according to the identification of the object 1 (for example, the ID of the object 1).

In the method provided in the present disclosure, the prop corresponding to the object 1 is used by default during the shooting. Certainly, during the shooting, the user can also replace the prop corresponding to the object 1 with another prop for shooting, so as to meet personalized requirements of the user.

Continuing referring to FIG. 2F, the interactive interface 26 may also include a control for selecting a shooting mode, an entry to an album, an entry to a prop page, an entry to a music page, a button for converting cameras, a button for controlling a playing speed, a button for adding a filter, a countdown button, a flashlight control button, and so on. Of course, the shooting page may further include entries or controls corresponding to other functions, which is not limited in this disclosure.

After the shooting is completed, a video preview page may be entered. The application 1 may, on the cellphone, exemplarily display an interactive interface 27 as shown in FIG. 2G, the interactive interface 27 being used for presenting a video preview page, in which the user can preview a video shot by using the prop corresponding to the object 1.

In addition, in order to facilitate the user editing and modifying the video in the video preview page, the interactive interface 27 may further include an entry to a music page, a button for adding a filter, a button for adding a sticker, a beautification button, a picture quality enhancement button, a button for adding text, and the like. The interactive interface 27 may further include a setting button, through which a browsing permission for the video may be set. The interactive interface 27 may further include a storage control, through which the target multimedia content obtained by shooting may be stored to the cellphone locally.

The interactive interface 27 may further include an entry label s10 for entering a posting page, and when the application 1 receives a trigger operation for the entry label s10, the cellphone exemplarily displays an interactive interface 28 as shown in FIG. 2H.

The interactive interface 28 is used for presenting a posting page, and as shown in FIG. 2H, the interactive interface 28 may include: an area 207 and a Post control s11.

The area 207 may include: areas 2071, 2072, and 2073.

The area 2071 is used for inputting title information of posted target multimedia content.

The area 2072 is used for presenting a cover of generated target multimedia content, such as presenting a thumbnail of a certain frame of played picture of the target multimedia content in a form of a card, and providing a function of selecting a cover of the target multimedia content.

The area 2073 is used for providing an entry to select a topic to which the target multimedia content belongs, such that the topic to which the target multimedia content belongs can be displayed in the area 2071; and the area 2073 may further provide an entry to select a target user, so as to facilitate reminding the target user of knowing that the user has posted the target multimedia content, wherein information of the selected user may be displayed in the area 2071.

In order to make it convenient for the user to be able to quickly select a topic to participate and a target user to be selected, some labels corresponding to topics in high fitness with the target multimedia content to be posted, as well as user labels in high fitness with the target multimedia content to be posted may be displayed in the area 2073, such that the user may trigger the corresponding topic label and user label to quickly select a user he wants to specify and specify a topic to participate.

Alternatively, a topic label and a label corresponding to a user which are in high fitness with the target multimedia content to be posted may be automatically added to the area 2071, that is, “topic 1 xxx”, “topic 2 xxx” and user “aaa” are automatically added to the area 2071 as shown in FIG. 2H.

The topic in high fitness with the target multimedia content to be posted may include a topic associated with the object 1, and the user in high fitness with the target multimedia content to be posted may include a user associated with the object 1. Since the target multimedia content is shot by using the prop corresponding to the object 1, the user and the topic associated with the object 1 are in high fitness with the target multimedia content.

Information of the user and topic associated with the object 1 may be acquired by the application 1 from the server according to the trigger operation of the user for the entry label s7, or the above information can be downloaded by the application 1 in advance and stored to a storage module of the cellphone, and acquired by the application 1 from the storage module of the cellphone when the user posts the target multimedia content.

A Post control s11 is used for posting the target multimedia content and related information corresponding to the target multimedia content, wherein the related information corresponding to the target multimedia content may include: information of the prop used for the target multimedia content, information of the specified user to be notified, information of the specified topic to participate, the title information input by the user in the area 2071, and the like.

When the application 1 receives a trigger operation (e.g., a click operation) for the Post control s11, the application 1 may transmit the target multimedia content and the related information corresponding to the target multimedia content to the server, such that the server may determine whether the target multimedia content meets a preset condition, i.e., verify whether there is a permission to acquire the resource provided by the object 1, and if there is a permission to acquire the resource provided by the object 1, a commodity associated with (provided or promoted by) the object 1 may be exchanged using the resource.

The preset condition may comprise at least one of the following:
1. The target multimedia content uses the prop corresponding to the object 1.
2. The topic to participate by the target multimedia content includes the specified topic associated with the object 1.
3. The user selected by the target multimedia content includes the target user associated with the object 1.

Assuming that the preset condition includes the above three conditions, if the server determines that the target multimedia content meets the above three conditions, it may be determined that the user has the permission to acquire the resource provided by the object 1.

Of course, the determination that the user has the permission to acquire the resource provided by the object 1, may also be made according to more conditions, exemplarily, a duration of the target multimedia content needs to be greater than a preset duration, which is not limited in the present disclosure, and may be, for example, 5 s, 10 s, and the like.

If it is determined that the target multimedia content meets the above condition(s), the server may transmit resource guidance information to the application 1, and the application 1 may, according to the received resource guidance information, display an interactive page where the user acquires the resource provided by the object 1, such that the user may acquire the resource provided by the object 1 through the interactive page.

In order to enable the user to clearly understand a posting state of a target video, a notification message may be presented to the user before a resource presenting page is displayed.

Exemplarily, the application 1 may notify the user that the target multimedia content has been successful posted and the user may enter an interactive page to acquire the resource provided by the object 1, by returning to the detail page corresponding to the object 1 and displaying a notification message in the detail page corresponding to the object 1. Exemplarily, the application 1 may, on the cellphone, exemplarily display an interactive interface 29 as shown in FIG. 2I.

Referring to FIG. 2I, the interactive interface 29 may include: an area 208 for presenting a notification message, which may include text, an icon, a symbol, etc., for example, as shown in FIG. 2I, a notification may be made by text “You have successfully posted a video, please come to participate in the interaction”.

The interactive interface 29 may further include an entry label s12 for entering the interactive page, such that when the application 1 receives a trigger operation of the user for the entry label s12, the application 1 may, on the cellphone, display an interactive interface 30 shown in FIG. 2J.

Referring to FIG. 2J, the interactive interface 30 is used for presenting the interactive page. The specific implementation of the interactive page is not limited in the present disclosure.

Exemplarily, the interactive interface 30 may include: areas 209, 210, and 211, and controls s13 and s14.

The area 209 may have therein displayed a title of the interactive page. For example, in the embodiment shown in FIG. 2J, the title of the interactive page may be “Lucky draw”.

The area 210 may have therein displayed prompt information that the resources are provided by the object 1, and related information of each type of resources provided by the object 1; in addition, the prompt information may include a name label of the object 1, through which a next-level page associated with the label may be entered, and so on. For example, in the embodiment shown in FIG. 2J, the area 210 has therein displayed “The following prizes are provided by #commodity provider aaa#”, and various types of prizes provided by the commodity provider aaa are presented by images.

The area 211 is an operation area for acquiring the resource provided by the object 1, where the user may input a trigger operation, the trigger operation including, for example, but not limited to, a swipe left/right operation, a swipe up/down operation, a click operation, and the like. In order to ensure that the user can clearly know the operation manner of acquiring the resource provided by the object 1, corresponding prompt information may be provided in the area 211. For example, in the embodiment shown in FIG. 2J, given that interaction with the user is performed in a manner of lucky draw, image information corresponding to the currently selected prize can be presented in the area 211, and it is prompted by text that it is possible to “swipe left/right”, “swipe up/down”, or the like.

The user can, by triggering an image corresponding to a certain prize, obtain the corresponding prize.

The control s13 is used for indicating exiting from acquiring the resource provided by the object 1 this time, such that the application 1 may return to the interactive interface 29 shown in FIG. 2I in response to a trigger operation for the control s13, and exit this interaction, that is, exit this lucky draw.

The control s14 is used for entering a resource detail presenting page, so as to facilitate the user viewing an acquired specific resource provided by the object 1 through the resource detail presenting page. For example, in the embodiment shown in FIG. 2J, interaction with the user is performed in a manner of lucky draw, then the resource detail presenting page may be a page for presenting detailed information of a won prize.

In addition, the interactive interface 30 may also include a Share control, a control for returning to the interactive interface shown in FIG. 2I, and the like.

The application 1 receives a trigger operation for the control s14, then the application 1 may, on the cellphone, exemplarily present an interactive interface 31 as shown in FIG. 2K, so as to present information of the specific resource provided by the object 1 acquired by the user.

Referring to FIG. 2K, the interactive interface 31 includes: an area 212.

The area 212 may have therein presented the information of the specific resource provided by the object 1 acquired by the user. For example, in the embodiment shown in FIG. 2J, interaction with the user is performed in a manner of lucky draw, then a resource detail presenting page shown in FIG. 2K may be a page for presenting detailed information of a won prize. As shown in FIG. 2K, assuming that a won prize is a physical item, a name of the physical item, a parameter of the physical item, an image for the physical item, and the like can be presented.

The specific resource provided by the object 1 acquired by the user can be obtained by the interaction of the application 1 with the server; if the server receives a resource acquiring request transmitted by the application 1, the server can determine the specific resource provided by the object 1 acquired by the user according to a preset manner, and transmit data of the specific resource provided by the object 1 acquired by the user to the application 1 for presentation.

In this process, the server may determine, according to the remaining number of each type of resources provided by the object 1, what type of resource the specific resource acquired by the user is, and the implementation of determining the specific resource acquired by the user by the server is not limited in the present disclosure. For example, the server may determine the prize acquired by the user according to the number of issuable physical items, coupons, and red envelopes corresponding to the current commodity provider aaa.

The resource acquired by the user can be issued to an account corresponding to the user, for example, a red envelope and coupon provided by the commodity provider that the user has won can be issued to a card package. In some cases, some information related to the specific resource acquired by the user also needs to be acquired, for example, if the prize won by the user is a physical item provided by the commodity provider and the user wants to receive the physical item, he also needs to fill in recipient information of receiving the physical item.

The interactive interface 31 may further include controls s15 and s16.

The control s15 is used for re-entering the interactive page.

The control s16 is used for entering an information acquisition page, so as to acquire information related to the specific resource acquired by the user. For example, the prize won by the user is a physical item provided by the commodity provider, then the application 1 may, in response to a trigger operation for the control s16, enter a recipient information filling page.

The interactive interface 31 may also include a control for closing the area 212 by the user, so as to facilitate the user closing the current interactive interface 31 and returning to another interface.

After the application 1 obtains the resource provided by the object 1, the application 1 may receive a notification message transmitted by the server, and the user may read the notification message from a message page.

Exemplarily, the application 1 exemplarily displays, on the cellphone, an interactive interface 32 as shown in FIG. 2L, which is primarily used for presenting a message page. In the interactive interface 31, various types of notification messages can be presented in chronological order of receiving messages, each notification message corresponds to one presenting unit, and based on a trigger operation of the user for the presenting unit of the corresponding message, detailed content of the notification message can be viewed.

The interactive interface 32 shown in FIG. 2L includes a notification message, transmitted by the server for notifying the user of acquiring the resource provided by the object 1, and a subject of the notification message may be, but is not limited to, an interactive message. The user clicks on a presenting unit corresponding to the notification message, then the application 1 may, on the cellphone, display an interactive interface 33 shown in FIG. 2M, where specific content of the notification message may be presented.

If the information related to the resource provided by the object 1 acquired by the user needs to be further improved, the interactive interface 33 may also have therein presented an entry label for entering an information acquisition page which is for the user to enter the information acquisition page, so as to acquire the information related to the specific resource acquired by the user.

In conjunction with the above embodiments, it can be seen that, in the method provided in the present disclosure, after a user shoots and posts multimedia content, it is determined that the posted multimedia content meets a preset condition, then an interaction session is entered, such that, by means of interaction, the interaction experience is improved, the diversified interaction requirements of the user are satisfied, and the understanding of the user for the target object is improved, thereby increasing the possibility of generating more interactions between the user and the target object.

Based on the foregoing description, in the embodiment of the present disclosure, taking an application as an example, the interaction method provided in the present disclosure will be elaborated in conjunction with the drawings and application scenarios.

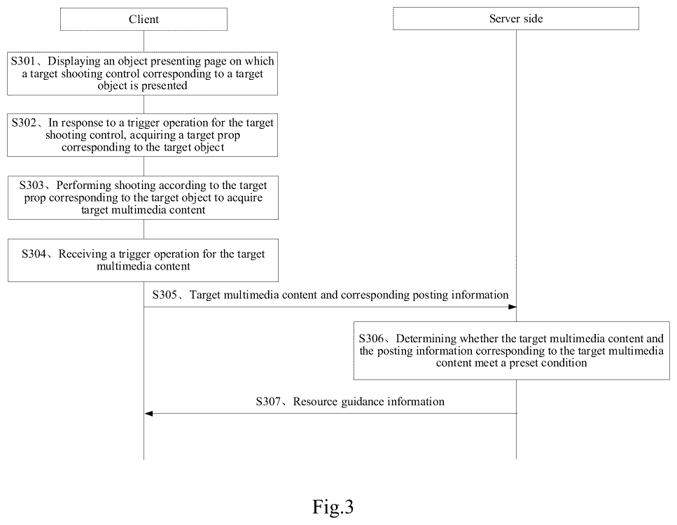

Referring to FIG. 3, FIG. 3 is a schematic flow diagram of an interaction method according to an embodiment of the present disclosure. As shown in FIG. 3, the interaction method provided in the present disclosure may comprise:

S301, displaying, by a client, an object presenting page on which a target shooting control corresponding to a target object is presented.

The application can display, in a screen of an electronic device, the object presenting page on which related information of a plurality of objects and target shooting controls corresponding to the objects may be presented, wherein the plurality of objects include the target object. Each object has a corresponding shooting control, and by triggering the shooting control, a video or image shooting page of an object corresponding to the shooting control can be entered.

The manner of triggering the application to present the object presenting page is not limited in the present disclosure.

As a possible implementation, the application may receive a trigger operation for a topic label in a playing page of multimedia content, and jump from the playing page of the multimedia content to a detail page of a topic in response to the trigger operation for the topic label in the playing page of the multimedia content; wherein the multimedia content played in the playing page is multimedia content obtained according to a prop corresponding to the object in the object presenting page, and the topic label is a label corresponding to a topic of the multimedia content played in the playing page; and then, the application, in response to a trigger operation for a participation label in the detail page of the topic, jumps from the detail page of the topic to the object presenting page of the plurality of object labels.

As another possible implementation, in response to a trigger operation for an entry label for entering the object presenting page in a resource presenting page, it jumps from a target subject page to the object presenting page; the target subject page is not limited in the present disclosure, for example, the target subject page may be a home page of the application, the resource presenting page in the application, and the like.

Of course, the object presenting page may also be entered in other ways. For example, in some cases, for example, if a user shoots a video using a prop corresponding to a certain object and posts such multimedia content, a link for entering an object presenting page may be added in a comment page of the multimedia content, such that the user may enter the object presenting page by clicking on the link added in the comment page.

The implementation of entering the object presenting page is not limited in the present disclosure.

In the object presenting page, related information corresponding to the plurality of objects and corresponding shooting controls can be presented through one area. Exemplarily, the object presenting page may be shown as FIG. 2A, and for the details, reference can be made to the detailed description of the embodiment shown in FIG. 2A, which is not repeated herein for brevity.

By inputting a trigger operation for the target shooting control corresponding to the target object, the application can directly or indirectly enter the shooting page, such that shooting is performed by using the prop corresponding to the target object to acquire the target multimedia content.

If the application, in response to a trigger operation for a target object label, indirectly enters the shooting page, exemplarily, as shown in the foregoing embodiment, the shooting page is entered by jumping from FIG. 2A to the interactive interface shown in FIG. 2D, and then jumping from the interactive interface shown in FIG. 2D to the interactive interface shown in FIG. 2F.

The application, in response to a trigger operation for a target object label, can also directly jump from the interactive interface shown in FIG. 2A to the interactive interface shown in FIG. 2F, so as to enter the shooting page.

S302, in response to a trigger operation for the target shooting control, acquiring, by the client, a target prop corresponding to the target object.

As described above, the application may load the prop corresponding to the target object, so as to perform shooting by using the prop corresponding to the target object. The application can download prop parameter information corresponding to the objects in advance and store the information to a storage module of a cellphone, and when the application receives the trigger operation for the target shooting control, the application can acquire the target prop corresponding to the target object from the storage module of the cellphone according to identification information (such as an ID of the target object) of the target object, or the application can acquire the target prop corresponding to the target object from a server according to the identification information (such as the ID of the target object) of the target object.

The prop corresponding to the object may be a prop individually preset for each object, associated with the object, and corresponding the object, and may be a prop having an object characteristic attribute. The prop may also be referred as the effects. Specifically, if the object is the commodity promoter (e.g., an anchor), the prop corresponding to the object may be a preset prop associated with the anchor, and may also be a prop having an anchor characteristic attribute (e.g., an anchor identification, an anchor avatar identification, an anchor nickname identification, or the like); and, if the object is the commodity provider (e.g., a store, a merchant), the prop corresponding to the object may be a preset prop associated with the store, and may also be a prop having a store characteristic attribute (e.g., a store identification, a store avatar identification, a store nickname identification, or the like).

S303, performing, by the client, shooting according to the target prop corresponding to the target object to acquire target multimedia content.

As a possible implementation, through the trigger operation for the target shooting control corresponding to the target object in the step S301, the application may acquire the identification information of the target object, acquire information of the target prop corresponding to the target object from the storage module of the electronic device or from the server according to the identification information of the target object, and perform shooting by using the target prop corresponding to the target object through the shooting page, so as to acquire the target multimedia content.

S304, receiving, by the client, a trigger operation for the target multimedia content.

S305, in response to a posting operation for the target multimedia content, transmitting, by the client, the target multimedia content and corresponding posting information to the server.

Correspondingly, the server receives the target multimedia content and the posting information corresponding to the target multimedia content which are transmitted by the client.

When the target multimedia content is posted, it is also possible to specify a topic to participate by the target multimedia content, specify a client (user) to be notified, and set a browsing permission for the target multimedia content, and the like, such that the posting information corresponding to the target multimedia content can include information of specifying the topic to participate by the target multimedia content, information of specifying the user to be notified, information of setting the browsing permission for the target multimedia content, video cover information, and the like.

In some possible cases, the application may acquire, from the server, information of a topic associated with the target object, information of a user associated with the target object, and the like, and when the target multimedia content is posted, the application may automatically bind the above information with the target multimedia content for posting, such that the server may transmit a notification message to a client corresponding to the user associated with the target object according to the above information, so as to prompt that the user has posted the target multimedia content using the prop corresponding to the target object, and such that the server adds the target multimedia content to a multimedia content collection corresponding to the topic associated with the target object.

The topic associated with the target object may be a preset topic which has an associated relationship with the target object, the topic associated with the target object may be a topic produced by the target object, and the topic associated with the target object may be related to attribute information of the target object, for example, when the target object is a commodity provider (such as a store), a topic associated with the commodity provider may be a topic of a commodity provided in the store, a topic related to an activity of the commodity in the store, and the like. The topic associated with the target object can be pre-specified and stored in the server.

A client (i.e., a user) associated with the target object may be a preset client (i.e., a user) which has an associated relationship with the target object, for example, when the target object is a commodity provider (e.g., a store), a client associated with the commodity provider may be an official account corresponding to the store, or when the target object is a commodity promoter (e.g., an anchor), a client corresponding to the commodity promoter may be an account corresponding to the anchor. The client (i.e., the user) associated with the target object may be pre-specified and stored in the server.

Of course, the user may also manually add another specified topic and a specified user he want to notify, and bind the specified topic and the specified user with the target multimedia content for posting.

S306, determining, by the server, whether the target multimedia content and the posting information corresponding to the target multimedia content meet a preset condition.

The preset condition may include one or more of: the target multimedia content using the prop corresponding to the target object, the client specified to be notified when the target multimedia content is posted including a target client corresponding to the target object, and the topic to participate by the target multimedia content when the target multimedia content is posted including a target topic corresponding to the target object.

Of course, the preset condition may also include other conditions, for example, a duration of the target multimedia content meeting a preset duration, specific content shot in the target multimedia content meeting a publication requirement, and the like.

Since in the shooting process, the user might change the used prop, and when posting, the user might change the topic to participate and the user specified to be notified, after the user posts the target multimedia content, the server can verify the target multimedia content through the above preset condition(s), so as to determine whether the user posting the target multimedia content has a permission to acquire a resource provided by the target object.

S307, in response to determining that the target multimedia content and the posting information corresponding to the target multimedia content meet the preset condition, transmitting, by the server, resource guidance information to the client.

If the server determines that the target multimedia content and the posting information corresponding to the target multimedia content meet the preset condition, it is indicated that the user posting the target multimedia content has the permission to acquire the resource provided by the target object, then the server transmits the resource guidance information to the application, such that the client displays the resource guidance information, and in respond to a trigger operation for the resource guidance information, presents acquired target resource information.

In the method provided in the embodiment, by means of a trigger operation for a target shooting control corresponding to a target object in an object presenting page, a target prop corresponding to the target object is acquired, shooting is performed by using the target prop corresponding to the target object, so as to acquire and post the target multimedia content; and in response to that a server determines that a preset condition is met according to the target multimedia content and posting information corresponding to the target multimedia content, it transmits resource guidance information to a client. The interaction method provided in the embodiment can, in an interactive manner, improve the interaction experience and meet the diversified interaction requirements of the user, and can improve the understanding of the user for the target object, thereby increasing the possibility of generating more interactions between the user and the target object.

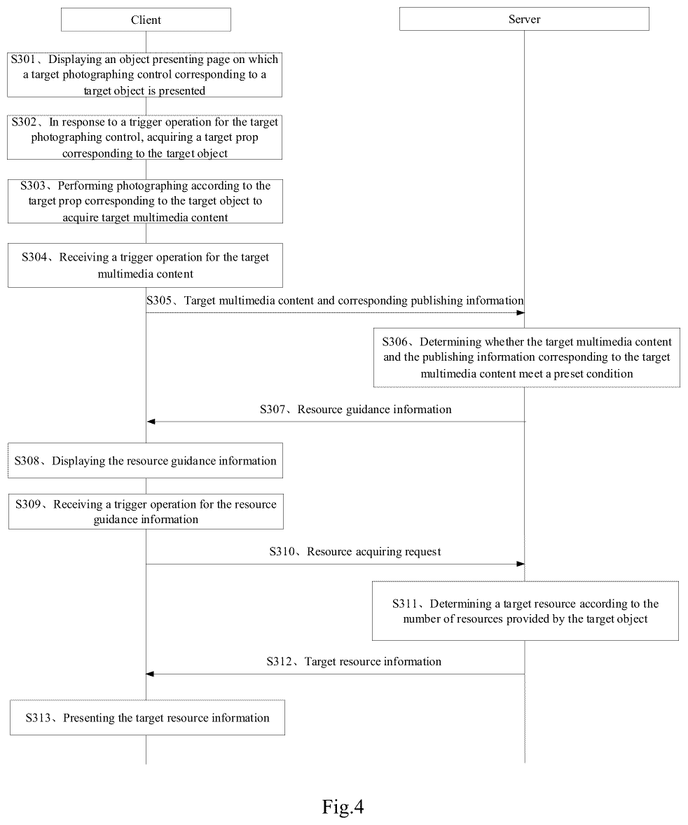

FIG. 4 is a schematic flow diagram of an interaction method according to another embodiment of the present disclosure. Referring to FIG. 4, the method provided in this embodiment may, on the basis of the embodiment shown in FIG. 3, after the S307, further comprise:

S308, displaying, by the client, the resource guidance information.

S309, receiving, by the client, a trigger operation for the resource guidance information.

S310, in response to the trigger operation for the resource guidance information, transmitting, by the client, a resource acquiring request to the server. Correspondingly, the server receives the resource acquiring request transmitted by the client.

S311, determining, by the server, a target resource according to the number of resources provided by the target object.

S312, transmitting, by the server, target resource information to the client. Correspondingly, the client receives the target resource information transmitted by the server.

S313, presenting, by the client, the target resource information.

The resource guidance information is used for guiding the user to acquire the resources provided by the target object, and therefore the possibility of interaction between the user and the target object is increased. The type of the resources provided by the target object is not limited in the present disclosure.

Exemplarily, for the implementation of the client displaying the resource guidance information and presenting the acquired target resource information in response to the trigger operation for the resource guidance information, reference may be made to the embodiments shown in FIGS. 2I to 2K in the foregoing embodiments and the detailed description of such embodiments, which is not repeated herein for brevity. The resource guidance information is information for prompting the user to acquire the resource, and the target resource information is information on the resource acquired by the user. For example, the resource guidance information may be presented in a resource guidance popup window, on which guidance copywriting “Congratulations on gaining the gift” and a trigger control “Receive Gift” can be presented, and a corresponding gift can be acquired by clicking on the control. The target resource information can also be presented in a resource presenting popup window, on which a resource name and a resource icon can be presented.

The interaction method provided in the embodiment can, in an interactive manner, improve the interaction experience and meet the diversified interaction requirements of the user, and can improve the understanding of the user for the target object, thereby increasing the possibility of generating more interactions between the user and the target object.

Exemplarily, the present disclosure also provides an interaction apparatus.

FIG. 5 is a schematic structural diagram of an interaction apparatus according to an embodiment of the present disclosure. Referring to FIG. 5, the interaction apparatus 500 provided in this embodiment comprises:
a display module 501 configured to display an object presenting page on which a target shooting control corresponding to a target object is presented;
a processing module 502 configured to, in response to a trigger operation for the target shooting control, acquire a target prop corresponding to the target object; and perform shooting according to the target prop to acquire target multimedia content; and
a communication module 503 configured to, in response to a posting operation for the target multimedia content, transmit the target multimedia content and corresponding posting information to a server, such that the server determines whether a preset condition is met,
wherein the communication module is further configured to receive resource guidance information which is transmitted by the server in response to the server determining that the preset condition is met.

As a possible implementation, the display module 501 is further configured to display the resource guidance information; and in response to a trigger operation for the resource guidance information, present target resource information.

As a possible implementation, the preset condition comprises at least one of: the posting information comprising topic information associated with the target object, the posting information comprising client information associated with the target object, or the target multimedia content comprising target prop information.

As a possible implementation, the processing module 502 is specifically configured to, in response to the trigger operation control, for the target shooting acquire identification information of the target object; and acquire the target prop corresponding to the target object according to the identification information of the target object.

As a possible implementation, the processing module 502 is further configured to, in response to the posting operation for the target multimedia content, acquire posting information corresponding to the target object which comprises client information associated with the target object; and the communication module 503 is specifically configured to transmit the target multimedia content and the client information to the server, such that the server transmits the target multimedia content to a client corresponding to the client information.

As a possible implementation, the processing module 502 is further configured to, in response to the posting operation for the target multimedia content, acquire posting information corresponding to the target object which comprises topic information associated with the target object; and the communication module 503 is specifically configured to transmit the target multimedia content and the topic information to the server, such that the server adds the target multimedia content to a multimedia content collection corresponding to the topic information.

As a possible implementation, the processing module 502 is specifically configured to, in response to the posting operation for the target multimedia content, acquire posting information corresponding to the target object; and receive a modification operation for the posting information; and acquire the modified posting information.

The communication module 503 is specifically configured to transmit the target multimedia content and the corresponding modified posting information to the server.

The interaction apparatus provided in this embodiment may be configured to perform the technical solution performed by the client in any of the foregoing method embodiments, and has the similar implementation principle and technical effects, for which reference may be made to the detailed description of the foregoing method embodiments, which is not repeated herein for brevity.

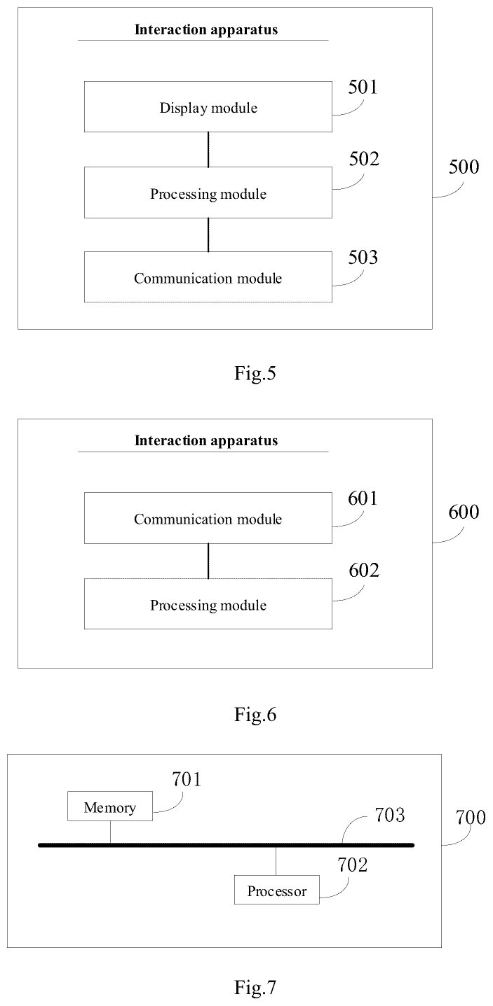

FIG. 6 is a schematic structural diagram of an interaction apparatus according to another embodiment of the present disclosure. Referring to FIG. 6, the interaction apparatus 600 provided in this embodiment comprises:
a communication module 601 configured to receive target multimedia content and corresponding posting information which are transmitted by a client; and
a processing module 602 configured to determine whether a preset condition is met according to the target multimedia content and the corresponding posting information;
wherein the communication module 601 is further configured to transmit resource guidance information to the client in response to determining that a preset condition is met.

As a possible implementation, the processing module 602 is further configured to obtain, according to identification information of a target object, information of a target prop corresponding to the target object, and transmit the information of the target prop corresponding to the target object to the client via the communication module 601.

As a possible implementation, the processing module 602 is further configured to obtain, according to identification information of a target object, information of a topic associated with the target object and information of a user associated with the target object, and transmit the information of the topic associated with the target object and the information of the user associated with the target object to the client via the communication module 601.

As a possible implementation, the processing module 602 is further configured to transmit the target multimedia content to a client corresponding to the client information.

As a possible implementation, the processing module 602 is further configured to add the target multimedia content to a multimedia content collection corresponding to the topic information.

The interaction apparatus provided in this embodiment may be configured to perform the technical solution performed by the server in any of the foregoing method embodiments, and has the similar implementation principle and technical effects, for which reference may be made to the detailed description of the foregoing method embodiments, which is not repeated herein for brevity.

FIG. 7 is a schematic structural diagram of an electronic device according to an embodiment of the present disclosure. Referring to FIG. 7, the electronic device 700 provided in this embodiment comprises: a memory 701 and a processor 702.

The memory 701 may be an independent physical unit, and may be connected with the processor 702 via a bus 703. The memory 701 and the processor 702 may also be integrated together, which is implemented by hardware, etc.

The memory 701 is configured to store program instructions, and the processor 702 calls the program instructions to perform the operations of any of the above method embodiments.

Optionally, when part or all of the method of the above embodiment is implemented by software, the above electronic device 700 may also include only the processor 702. The memory 701 configured to store a program is located outside the electronic device 700, and the processor 702, which is connected with the memory via circuits/wires, is configured to read and execute the program stored in the memory.

The processor 702 may be a central processing unit (CPU), a network processor (NP), or a combination of the CPU and NP.

The processor 702 may further include a hardware chip. The above hardware chip may be an application-specific integrated circuit (ASIC), a programmable logic device (PLD), or a combination thereof. The above PLD may be a complex programmable logic device (CPLD), a field-programmable gate array (FPGA), a generic array logic (GAL), or any combination thereof.

The memory 701 may include a volatile memory, such as a random-access memory (RAM); the memory may also include a non-volatile memory, such as a flash memory, a hard disk drive (HDD) or a solid-state drive (SSD); and the memory may also include a combination of the above types of memories.

An embodiment of the present disclosure further provides a readable storage medium, comprising: computer program instructions; wherein the computer program instructions, when executed by at least one processor of an electronic device, implement the interaction method according to any of the method embodiments described above.

An embodiment of the present disclosure further provides a computer program product, comprising a computer program stored in a readable storage medium, wherein at least one processor of the electronic device can read the computer program from the readable storage medium, and the at least one processor executes the computer program to cause the electronic device to implement the interaction method according to any of the method embodiments described above.

It should be noted that, relational terms such as “first” and “second”, herein, are only used for distinguishing one entity or operation from another entity or operation without necessarily requiring or implying any such actual relation or order between these entities or operations. Moreover, the term “comprise”, “include”, or any other variation thereof, is intended to encompass a non-exclusive inclusion, such that a process, method, article, or device comprising a list of elements not only includes those elements but also includes other elements not expressly listed, or also includes elements inherent to such a process, method, article, or device. Without more limitations, an element defined by a statement “comprising a . . . ” does not exclude the presence of another identical element in a process, method, article, or device that includes the element.

The above only describes the specific embodiments of the present disclosure, which enable those skilled in the art to understand or implement the present disclosure. Various modifications to these embodiments will be apparent to those skilled in the art, and the general principles defined herein may be implemented in other embodiments without departing from the spirit or scope of the present disclosure. Therefore, the present disclosure will not be limited to these embodiments described herein, but conform to the widest scope consistent with the principles and novel features disclosed herein.

What is claimed is:

1. An interaction method, comprising:
displaying an object presenting page on which a target shooting control corresponding to a target object is presented;
in response to a trigger operation for the target shooting control, acquiring target effects corresponding to the target object;
performing shooting according to the target effects to acquire target media content;
in response to a posting operation for the target media content, transmitting the target media content and corresponding posting information to a server, such that the server determines whether a preset condition is met; and
receiving resource guidance information which is transmitted by the server in response to the server determining that the preset condition is met.

2. The interaction method according to claim 1, further comprising:
displaying the resource guidance information; and
in response to a trigger operation for the resource guidance information, presenting target resource information.

3. The interaction method according to claim 1, wherein the preset condition comprises at least one of: the posting information comprising topic information associated with the target object, the posting information comprising client information associated with the target object, or the target media content comprising target effects information.

4. The interaction method according to claim 1, wherein the in response to a trigger operation for the target shooting control, acquiring target effects corresponding to the target object, comprises:
in response to the trigger operation for the target shooting control, acquiring identification information of the target object; and
acquiring the target effects corresponding to the target object according to the identification information of the target object.

5. The interaction method according to claim 1, wherein the in response to a posting operation for the target media content, transmitting the target media content and corresponding posting information to a server, comprises:
in response to the posting operation for the target media content, acquiring posting information corresponding to the target object which comprises client information associated with the target object; and
transmitting the target media content and the client information to the server, such that the server transmits the target media content to a client corresponding to the client information.

6. The interaction method according to claim 1, wherein the in response to a posting operation for the target media content, transmitting the target media content and corresponding posting information to a server, comprises:
in response to the posting operation for the target media content, acquiring posting information corresponding to the target object which comprises topic information associated with the target object; and
transmitting the target media content and the topic information to the server, such that the server adds the target media content to a media content collection corresponding to the topic information.

7. The interaction method according to claim 1, wherein the in response to a posting operation for the target media content, transmitting the target media content and corresponding posting information to a server, comprises:
in response to the posting operation for the target media content, acquiring posting information corresponding to the target object;
receiving a modification operation for the posting information;
acquiring modified posting information; and
transmitting the target media content and the corresponding modified posting information to the server.

8. An interaction method, comprising:
receiving target media content and corresponding posting information which are transmitted by a client;
determining whether a preset condition is met according to the target media content and the corresponding posting information; and
transmitting resource guidance information to the client in response to determining that the preset condition is met.

9. A non-transitory computer-readable storage medium, comprising: computer program instructions;
wherein the computer program instructions, when executed by at least one processor of an electronic device, causing the electronic device to implement the following interaction operations:
displaying an object presenting page on which a target shooting control corresponding to a target object is presented;
in response to a trigger operation for the target shooting control, acquiring target effects corresponding to the target object;
performing shooting according to the target effects to acquire target media content;
in response to a posting operation for the target media content, transmitting the target media content and corresponding posting information to a server, such that the server determines whether a preset condition is met; and
receiving resource guidance information which is transmitted by the server in response to the server determining that the preset condition is met.

10. The storage medium according to claim 9, wherein the computer program instructions, when executed by the at least one processor of the electronic device, causing the electronic device to further implement the following operations:
displaying the resource guidance information; and
in response to a trigger operation for the resource guidance information, presenting target resource information.

11. The storage medium according to claim 9, wherein the preset condition comprises at least one of: the posting information comprising topic information associated with the target object, the posting information comprising client information associated with the target object, or the target media content comprising target effects information.

12. The storage medium according to claim 9, wherein the in response to a trigger operation for the target shooting control, acquiring target effects corresponding to the target object, comprises:
in response to the trigger operation for the target shooting control, acquiring identification information of the target object; and
acquiring the target effects corresponding to the target object according to the identification information of the target object.

13. The storage medium according to claim 9, wherein the in response to a posting operation for the target media content, transmitting the target media content and corresponding posting information to a server, comprises:
in response to the posting operation for the target media content, acquiring posting information corresponding to the target object which comprises client information associated with the target object; and
transmitting the target media content and the client information to the server, such that the server transmits the target media content to a client corresponding to the client information.

14. The storage medium according to claim 9, wherein the in response to a posting operation for the target media content, transmitting the target media content and corresponding posting information to a server, comprises:
in response to the posting operation for the target media content, acquiring posting information corresponding to the target object which comprises topic information associated with the target object; and
transmitting the target media content and the topic information to the server, such that the server adds the target media content to a media content collection corresponding to the topic information.

15. The storage medium according to claim 9, wherein the in response to a posting operation for the target media content, transmitting the target media content and corresponding posting information to a server, comprises:
in response to the posting operation for the target media content, acquiring posting information corresponding to the target object;
receiving a modification operation for the posting information;
acquiring modified posting information; and
transmitting the target media content and the corresponding modified posting information to the server.

16. A non-transitory computer-readable storage medium, comprising: computer program instructions;
wherein the computer program instructions, when executed by at least one processor of an electronic device, causing the electronic device to implement the interaction method according to claim 8.

17. An electronic device, comprising: a memory and a processor;
wherein the memory is configured to store computer program instructions; and
the processor is configured to execute the computer program instructions to cause the electronic device to implement the interaction method according to claim 1.

18. An electronic device, comprising: a memory and a processor;
wherein the memory is configured to store computer program instructions; and
the processor is configured to execute the computer program instructions to cause the electronic device to implement the interaction method according to claim 2.

19. An electronic device, comprising: a memory and a processor;
wherein the memory is configured to store computer program instructions; and
the processor is configured to execute the computer program instructions to cause the electronic device to implement the interaction method according to claim 3.

20. An electronic device, comprising: a memory and a processor;
wherein the memory is configured to store computer program instructions; and
the processor is configured to execute the computer program instructions to cause the electronic device to implement the interaction method according to claim 8.
